(19) United States
(12) Patent Application Publication
(10) Pub. No.: US 2014/0204910 A1
(43) Pub. Date: Jul. 24, 2014

(54) Individual User Equipment Settings in Radio Access Network

(71) Applicants: Walter Müller, Upplands Väsby (SE); Andreas Olsson, Stockholm (SE)

(72) Inventors: Walter Müller, Upplands Väsby (SE); Andreas Olsson, Stockholm (SE)

(73) Assignee: TELEFONAKTIEBOLAGET L M ERICSSON (PUBL), Stockholm (SE)

(21) Appl. No.: 14/342,408

(22) PCT Filed: Sep. 7, 2011
(86) PCT No.: PCT/SE2011/051080

§ 371 Date: Mar. 3, 2014

(51) Int. Cl. H04W 36/00

(52) U.S. Cl. CPC H04W 36/0083
USPC 370/331

(57) ABSTRACT

A radio base station in a wireless communication network and a method in a radio base station for providing service to a user equipment is provided. The method comprises establishing a connection between the user equipment and the radio base station, and receiving, from a network node, usage statistics of the user equipment. The method further comprises determining at least one parameter relating to the provision of the service to the user equipment based on the received usage statistics of the user equipment.

### TECHNICAL FIELD

Embodiments herein relate generally to providing a service to a user equipment in wireless communication networks and in particular to determining parameters relating to the provision of the service individually for the user equipment.

### BACKGROUND

Radio networks comprise deployed radio base stations, RBSs. The RBSs communicate with user equipments, UEs, which are being served by the RBSs. Typically, one RBS serves a one or several radio cell's and any UE present in the cell is served by the RBS serving the cell. There are many different vendors and manufacturers of UEs and each vendor typically has multiple hardware versions of their different models.

Some UEs or hardware models can have different performance and capabilities. Just as an example, some UEs may support only speech, speech and default best effort services, some UEs support video conference and some UEs support the downloading and use of different applications, commonly known as Apps.

The use of so-called smartphones, e.g. iPhones and Android phones, has increased in the last few years. Different subscribers may have very different behaviour in a radio network. For example, one subscriber might generate a very small bursty traffic pattern that is mostly presence signalling when making use of different Apps on the smartphone. Another subscriber may generate long conversations, for example frequently being engaged in telephone meetings. Further, another kind of UE is laptops. The laptop may have a traffic pattern which comprises few but very large bursts of data.

Different services have different requirements and also different UEs have different capabilities and performance. Just as an example, for one UE having a first type of hardware, the optimal handover threshold could be 3 dB and for a second UE having a second type of hardware, the optimal handover threshold could instead be 6 dB.

The RBSs of the radio network are required to provide services of different kinds to this multitude of UEs and with a satisfactory level of quality. Since UEs have different hardware with different performances, the RBSs have a difficult task of providing different services with a minimum level of quality. In order to be able to at least keep a minimum level of quality, the RBSs have to make different compromises, which may result in a perceived poor level of quality.

### SUMMARY

It is an object of the exemplifying embodiments to address at least some of the problems outlined above. In particular, it is an object of the exemplifying embodiments to provide a radio base station in a wireless communication network and a method in the radio base station for providing service to a user equipment, wherein at least one parameter relating to the provision of the service to the user equipment is determined based on the received usage statistics of the user equipment. These objects and others may be obtained by providing a radio base station and a method in a radio base station according to the independent claims attached below.

According to an aspect, a method in a radio base station, in a wireless communication network, for providing service to a user equipment is provided. The method comprises establishing a connection between the user equipment and the radio base station, and receiving, from a network node, usage statistics of the user equipment. The method further comprises determining at least one parameter relating to the provision of the service to the user equipment based on the received usage statistics of the user equipment.

According to an aspect, a radio base station in a wireless communication network is provided, wherein the radio base station is adapted to provide service to a user equipment. The radio base station is adapted to establish a connection between the user equipment and the radio base station, and to receive, from a network node, usage statistics of the user equipment. The radio base station is further adapted to determine at least one parameter relating to the provision of the service to the user equipment based on the received usage statistics of the user equipment.

The radio base station and the method therein have several advantages. One advantage is that the perceived level of quality is increased as the parameters relating to the requested service can be determined individually for the UE. This leads to increased performance in the network, e.g. for handover in less dropped calls or connections. Another advantage is that control signalling is reduced. Still an advantage is that the resources and capacity of the network is better used.

### BRIEF DESCRIPTION OF DRAWINGS

Embodiments will now be described in more detail in relation to the accompanying drawings, in which:

FIG. 1 is a flowchart of an exemplifying embodiment of a method in a RBS for providing a service to a UE.

FIG. 2 is a block diagram of an exemplifying embodiment of a RBS adapted to provide a service to a UE.

FIGS. 3a-3d are signalling diagrams illustrating exemplifying messages to be used for the RBS to receive usage statistics information.

FIGS. 4a and 4b are block diagrams illustrating two examples of implementation of a statistics node in a wireless communication network.

### DETAILED DESCRIPTION

Briefly described, exemplifying embodiments of a radio base station, RBS, and a method therein are provided for providing a service to a UE, wherein the RBS receives usage statistics of the UE. The RBS determines at least one parameter relating to the provision of the service to the UE based on the received usage statistics of the UE.

The embodiments of the RBS and the method therein allows the RBS to get information about the behaviour, performance and configuration of the UE, so that the RBS may make use of this information to individually adapt or determine different parameters, such as for examples thresholds, for the UE, or Radio Access Bearers (RABs), for providing a service to the UE. This is possible due to the use of Radio Resource Control (RRC) signalling which is individual.

The embodiments will be described herein in a wireless communication network being a Long Term Evolution, LTE, communication network. However, the embodiments are not restricted to an LTE communication network.

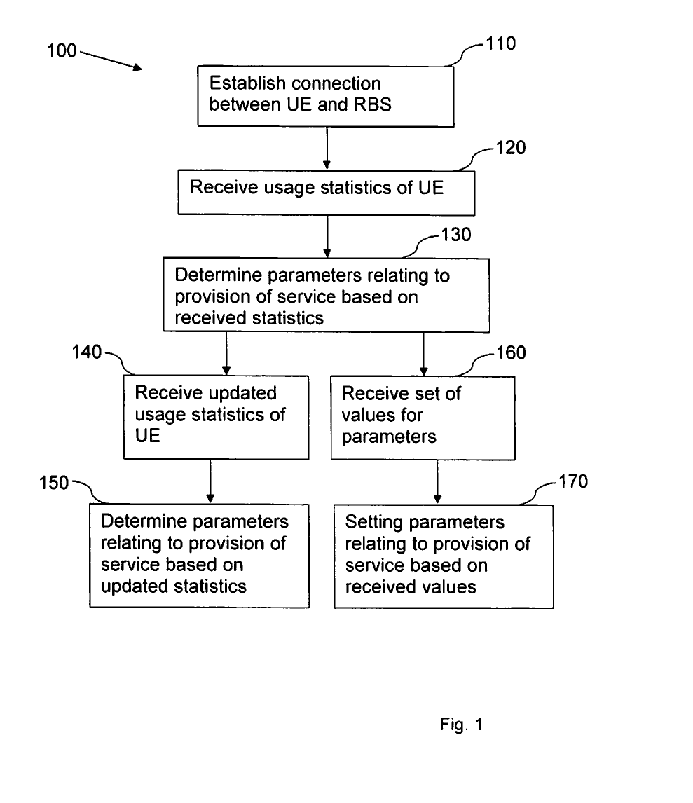

FIG. 1 is a flowchart of an exemplifying embodiment of a method in an RBS for providing a service to a UE.

FIG. 1 illustrates the method comprising establishing 110 a connection between the UE and the RBS, and receiving 120, from a network node, usage statistics of the UE. The method further comprises determining 130 at least one parameter relating to the provision of the service to the UE based on the received usage statistics of the UE.

In order for a RBS to provide a service to a UE, the UE must first be connected to the RBS and the network. It shall be pointed out that it is not the RBS that provides the end service, but typically a server higher up in the network. The RBS supports and maintains the connections which the service uses by setting up different radio bearers for different services to and from the UE. The RBS also sets up connections to serving gateways that in turn connect to the service actually providing the end service. By the RBS providing a service to a UE is meant that the RBS sets up the different radio bearers by means of which, the service is provided to the UE. Once the UE is connected to the RBS, the RBS is enabled to provide a requested service to the UE. When the connection is established, the RBS receives usage statistics of the UE from a network node. The usage statistics comprise different kinds of information. For example, the usage statistics of the UE comprises information on which services the UE most often is engaged with, e.g. speech, data transfer, surfing the Internet, using specific Apps and so on. Another example of information comprises in the usage statistics of the UE is the average length of providing the service, e.g. a speech service is, on average used for 5 minutes or 30 minutes and then the use of the service is ended, or a specific App normally generates traffic with small bursts of traffic during 20 minutes but with relatively long intervals between the bursts. Yet an example of information comprised in the usage statistics of the UE is roaming habits for the UE when using the requested service, e.g. when on a bus the UE is often engaged in a certain service typically requiring frequent handovers. Still another example of the usage statistics of the UE is the brand, type, model and/or version of the UE in question. The individual traffic pattern or traffic statistics of the UEs may be collected from real traffic, as may the individual performance of the UEs. The performance of individual UEs may also be collected from UE testing in a lab.

Once the RBS has received the usage statistics of the UE, the RBS can then determine at least one parameter relating to the provision of the service to the UE based on the received usage statistics of the UE. Depending on the service being requested, different parameters need to be set to different values. This will be explained in more detail below.

The exemplifying embodiment of the method has several advantages. One advantage is that the perceived level of quality is increased as the parameters relating to the requested service can be determined individually for the UE. This leads to increased performance in the network, e.g. for handover in less dropped calls or connections. Another advantage is that control signalling is reduced. Still an advantage is that the resources and capacity of the network is better used.

According to an embodiment, the at least one parameter relating to the provision of the service to the UE relates to handover from the RBS to a target RBS.

As disclosed above, different services have different requirements and also different UEs have different performance. For one UE having a first type of hardware, the optimal handover threshold is e.g. 3 dB and for a second UE having a second type of hardware, the optimal handover threshold is e.g. 6 dB. When the RBS receives the usage statistics of the UE, the RBS is enabled to determine e.g. a handover threshold to be 3 dB meaning that a signal strength target cell shall be 3 dB stronger than the signal strength of the serving cell.

According to an embodiment, the at least one parameter relating to the provision of the service to the UE relates to length of periods of user inactivity before the RBS initiates a release of the UE.

As disclosed above, different UEs may make use of different services. This can be dependent upon the type of UE, e.g. a laptop, smartphone or a mobile station. It can also be dependent upon the user of the UE. A first user may mostly use his/her smartphone for speech whereas a second user may mostly use his/her smartphone for surfing the Internet. A third user also having a smartphone may use his/her smartphone mostly by making use of different Apps. Depending on the UE itself and depending on the use of the UE, the traffic pattern may vary quite substantially. One user may have relatively long periods of inactivity but may still regularly generate a burst of traffic. For such a user, it might be advantageous to not initiate a release of the UE until after a relatively long time of inactivity, in order to avoid having to re-establish the connection over and over again, which may induce excessive/unnecessary signalling. Another user may have relatively short periods of inactivity. For such a user, it might be advantageous to initiate a release after a relatively short period of inactivity in order to save and free resources to be used by other UEs. An activity level does not have to be on a subscriber level, it could also be UE vendor, or UE vendor model, or operating system on the UE, e.g. Android 2.0 or Android 2.3 etc.

According to yet an embodiment, the at least one parameter relating to the provision of the service to the UE relates to Discontinuous Reception (DRX) configuration settings.

According to yet an embodiment, the at least one parameter relating to the provision of the service to the UE relates to User Plane properties for Radio Link Control (RLC) and Media Access Control (MAC) protocols or Hybrid Automatic Repeat ReQuest (HARQ) settings.

The at least one parameter relating to the provision of the service to the UE does not have to be an exact value. In one example, the UE or Evolved Radio Access Bearers (E-RABs) are assigned a profile tag towards the RBS. Then the RBS interprets what the tag is translated to for the at least one parameter. The translation is in one example standardised and in another example configured from a management system or hard coded in the software of the RBS. Such a scheme may save size of signalling messages.

In one example, the parameter indicates an interval. The at least one parameter is in another example a threshold value indicating that when the threshold is reached or exceeded, certain actions relating to the provision of the service is taken. Some examples of actions taken as a threshold is reached or exceeded are handover, initiation of release of the UE, change of coding scheme, change of bandwidth allocation, change of link adaptation scheme, change of scheduling strategy e.g. to reduce delays, change of buffer size allocation, DRX configuration, target selection for handover and so on. The at least one parameter is in yet an example a resource allocation recommendation.

According to an embodiment, the establishment 110 of the connection comprises receiving a connection request message from the UE and setting up a connection to a Mobile Management Entity, MME.

The establishment of the connection may be due to different reasons. In this example, a user of a UE decides to make use of a service. In order to make use of the service, and for the RBS to be able to provide the service to the UE, the UE must first be connected to the RBS and the network. The UE in this case sends a connection request message to the RBS, wherein the RBS sets up a connection to the MME.

According to yet an embodiment, the establishment 110 of the connection comprises receiving a handover request message from a Mobile Management Entity, MME and executing the handover.

In this example, the UE is already making use of the service by means of a source RBS and is moving towards the RBS, the RBS then being a target RBS. The MME is in control of the handover and sends a handover request message to the RBS, wherein the RBS executes the handover from a source RBS to itself being the target RBS. This type of handover is also called S1-handover in the example of an LTE communication network.

According to still an embodiment, the establishing 110 of the connection comprises receiving a handover request message from a source RBS and executing the handover.

In this example, the MME is not responsible for the handover, but the source RBS and the target RBS perform the handover in-between themselves. This is also called X2-handover in the example of an LTE communication network.

According to an embodiment, the received usage statistics of the UE comprises a recommended parameter configuration, wherein the determination 130 of the at least one parameter relating to the provision of the service to the UE are based at least partly on the parameter configuration.

In this example, the usage statistics of the UE comprises a recommended parameter configuration. In case the usage statistics of the UE do not comprise any other information, the RBS can use the recommended parameter configuration when determining the parameters relating to the provision of the service to the UE. The usage statistics of the UE may additionally also comprise information as described above, e.g. the brand, version, model of the UE and information pertaining to the different traffic patterns usually generated by the UE. In such a scenario, the RBS is enabled to determine the values of the at least one parameter relating to the provision of the service to the UE at least partly based on the recommended parameter confirmation. As an example, assume the RBS is subjected to a very heavy traffic load and the recommended parameter configuration indicates that the inactivity timer should be set relatively long and/or the handover threshold for handing over a UE to a target RBS is relatively high. In such a scenario, the RBS is enabled to determine the at least one parameter relating to the provision of the service to the UE taking both the recommended parameter configuration and the current traffic, or load, situation into account. The result may be for example that the inactivity timer threshold is set to a lower value than indicated in the recommended parameter configuration and/or that the handover threshold is set to a lower value than in the recommended parameter configuration.

According to an embodiment, the method further comprises receiving 140, from the network node, updated usage statistics of the UE from a Mobile Management Entity, MME, and re-determining 150 the at least one parameter relating to the provision of the service to the UE based on the received updated usage statistics of the UE.

In an example, a connection between the UE and the RBS has already been established and a service is being provided to the UE. During the provision of the service to the UE, the RBS receives 140 updated usage statistics of the UE from the MME. This implies that the usage statistics have been altered as they are updated which may result in that the already determined at least one parameter relating to the provision of the service to the UE is not optimal any longer. Then the RBS re-determines 150 the at least one parameter relating to the provision of the service to the UE. This way, the RBS tries to always have an optimal parameter setting for the provision of the service to the UE.

According to an embodiment, the method further comprises receiving 160, from the network node, a value for at least one parameter relating to the provision of the service to the UE and 170 determining the at least one parameter relating to the provision of the service to the UE according to the received value.

In this example, the RBS receives 160 a value that the RBS shall use for the at least one parameter relating to the provision of the service to the UE. In such a case, the RBS determines 170 or sets the value of the at least one parameter relating to the provision of the service to the UE to be the same as the received value. This means the RBS is not allowed to choose any other value for the parameter than the received value.

In an example, the RBS receives usage statistics of the UE, recommended parameter configuration comprised in the usage statistics and a value for at least one parameter relating to the provision of the service to the UE. In this example, the RBS determines some parameters relating to the provision of the service to the UE based the usage statistics, the RBS determines some parameters relating to the provision of the service to the UE based the recommended parameter configuration, the RBS determines some parameters based on the usage statistics in combination with the current traffic load of the RBS and also determines some parameters to be the values having been received from the network node.

Embodiments herein also relates to a radio base station, RBS, in a wireless communication network, the RBS being adapted to provide a service to a UE. The RBS has the same objects and advantages as the method therein. As a consequence, the RBS will only be described in brief in order to avoid unnecessary repetition.

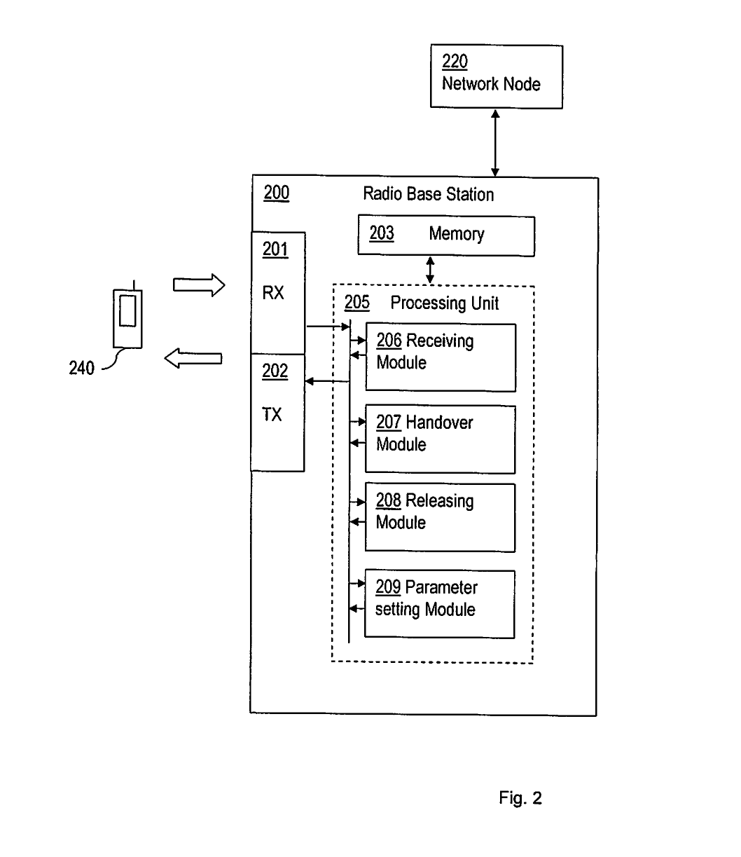

An exemplifying embodiment of such an RBS will now be described with reference to FIG. 2.

FIG. 2 is a block diagram of an exemplifying embodiment of an RBS adapted to provide service to a UE.

FIG. 2 illustrates the RBS 200 being adapted to establish a connection between the UE 240 and the RBS 200, and to receive, from a network node 220, usage statistics of the UE 240. The RBS 200 is further adapted to determine at least one parameter relating to the provision of the service to the UE 240 based on the received usage statistics of the UE.

FIG. 2 is an exemplifying illustration of an RBS. FIG. 2 illustrates the RBS 200 comprising a transmitting arrangement 202 and a receiving arrangement 201 by means of which the RBS communicates wirelessly with the UE 240. FIG. 2 illustrates a network node 220 being connected to or communicating with the RBS 200. The communication between the RBS 200 and the network node 220 may be performed wirelessly, either by means of the receiving and transmitting arrangements 201 and 202 or by an alternative (not shown) receiving/transmitting arrangement. The not shown alternative receiving/transmitting arrangement may also be wire-based and then the RBS 200 and the network node 220 communicate by wire/cable.

The RBS 200 is also illustrated comprising a processing unit 205 comprising exemplifying dedicated modules 206-209 to receive communication from the UE 240 and the network node 220; to execute handover to or from a second (not shown) RBS; to determine at least one parameter relating to the provision of the service to the UE 240; and to initiate and release the connection with the UE 240. It shall be pointed out that this is merely an example and the RBS may comprise other or more modules and/or units. As an example, an RBS typically comprises a scheduler. However, this is not illustrated in FIG. 2 for simplicity reasons.

According to an embodiment, the at least one parameter relating to the provision of the service to the UE 240, relates to handover from the RBS 200 to a target RBS.

According to an embodiment, the at least one parameter relating to the provision of the service to the UE 240, relates to length of periods of user inactivity before the RBS 200 initiates a release of the UE 240.

It shall be pointed out that by user inactivity is meant that the user of the UE does not use his/her UE in a way that generates traffic to or from the UE.

According to yet an embodiment, the RBS 200 is adapted to establish the connection by receiving a connection request message from the UE 240 and setting up a connection to a Mobile Management Entity, MME.

According to still an embodiment, the RBS 200 is adapted to establish the connection by receiving a handover request message from a Mobile Management Entity, MME and executing the handover.

According to an embodiment, the network node 220 is the MME.

In this example, the RBS 200 receives the usage statistics of the UE 240 from the MME. This will be described in more detail below.

According to an embodiment, the network node 220 is a statistics node comprising usage statistics of UEs and located in a radio access network or a core network of the wireless communication network.

The network node 220 is in one example the MME and in another example incorporated into the MME. In yet an example, the network node 220 is a standalone node, called a statistics node, or simply a knowledge node. The statistics node is in one example implemented in the radio access network and in another example implemented or located in the core network. This will be more described and exemplified below.

According to an embodiment, the RBS 200 is adapted to establish the connection by receiving a handover request message from a source RBS and executing the handover.

According to still an embodiment, the network node 220 is the source RBS.

In the example of X2-handover, the source and target RBSs handle the handover of the UE themselves. In this scenario, the target RBS 200 receives the usage statistics of the UE 240 from the source RBS, which in this example is the network node 220.

According to yet an embodiment, the received usage statistics of the UE 240 comprises a recommended parameter configuration, and wherein RBS 200 is adapted to determine the parameters relating to the provision of the service to the UE 240 based at least partly on the recommended parameter configuration.

According to an embodiment, the RBS 200 is adapted to receive updated usage statistics of the UE 240 from a Mobile Management Entity, MME, and to re-determine the parameters relating to the provision of the service to the UE 240 based on the received updated usage statistics of the UE 240.

According to still an embodiment, the RBS 200 is adapted to receive a value for at least one parameter relating to the provision of the service to the UE 240 and to determine the at least one parameter relating to the provision of the service to the UE 240 according to the received value.

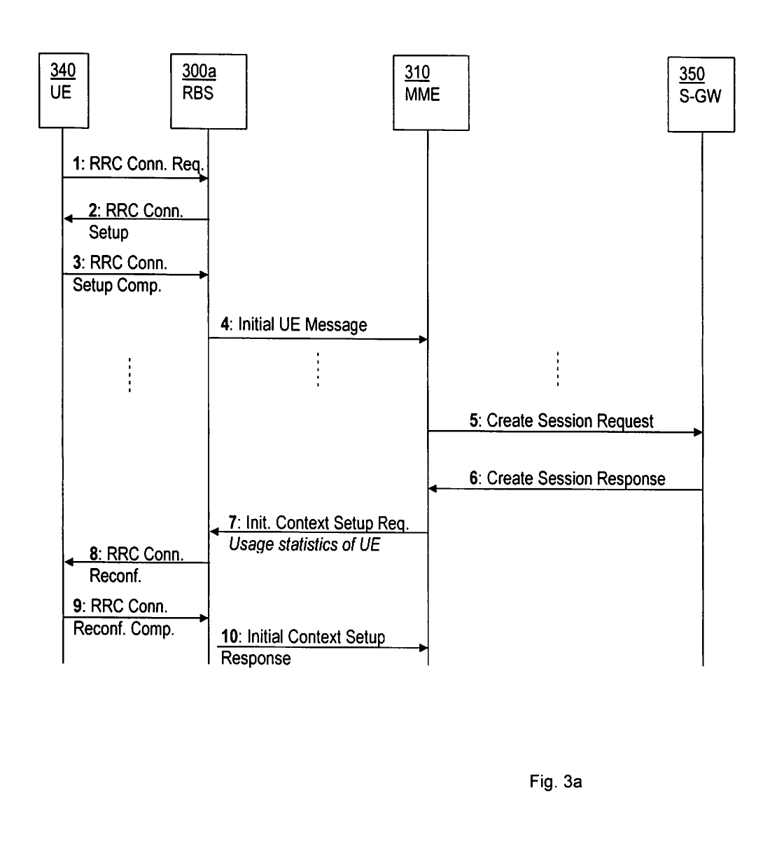

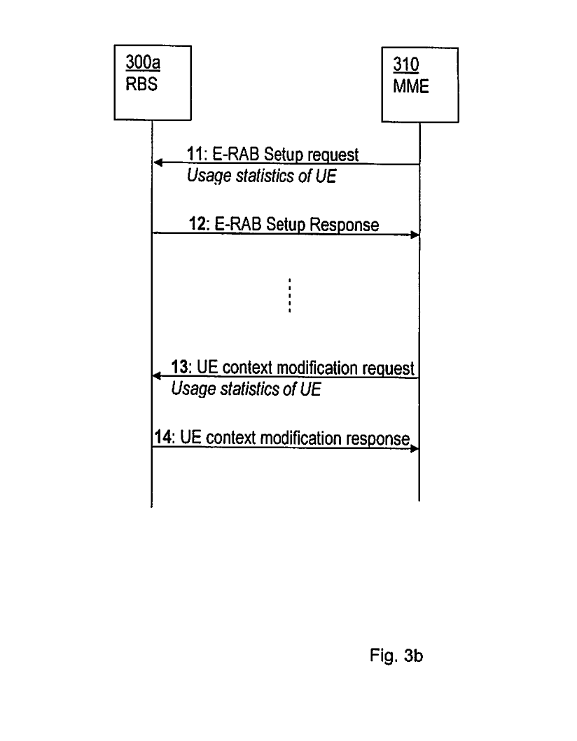

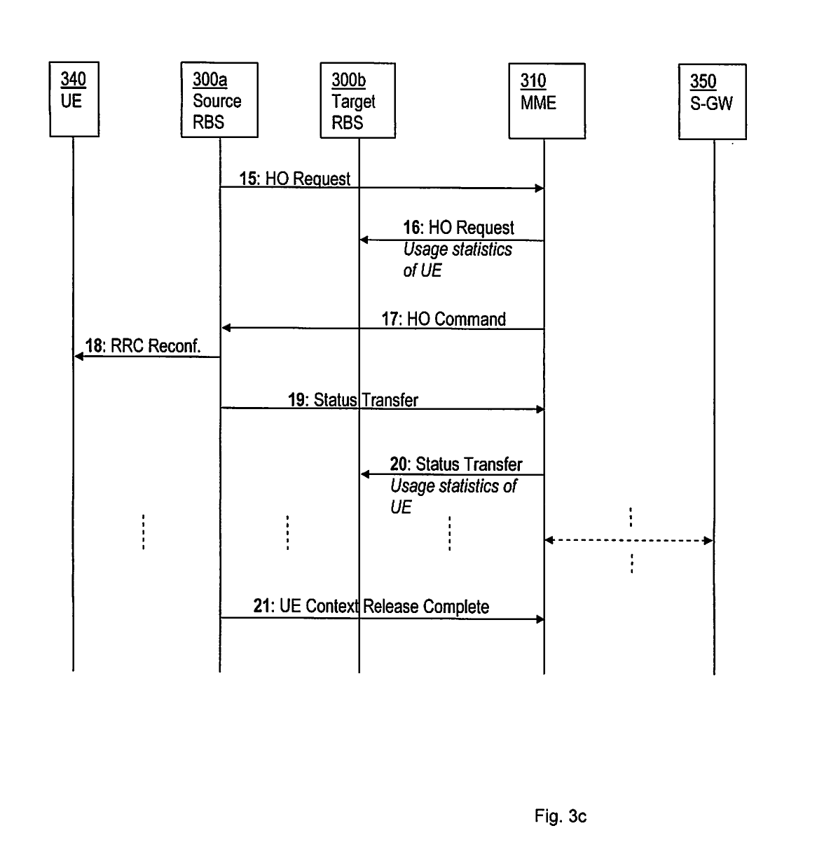

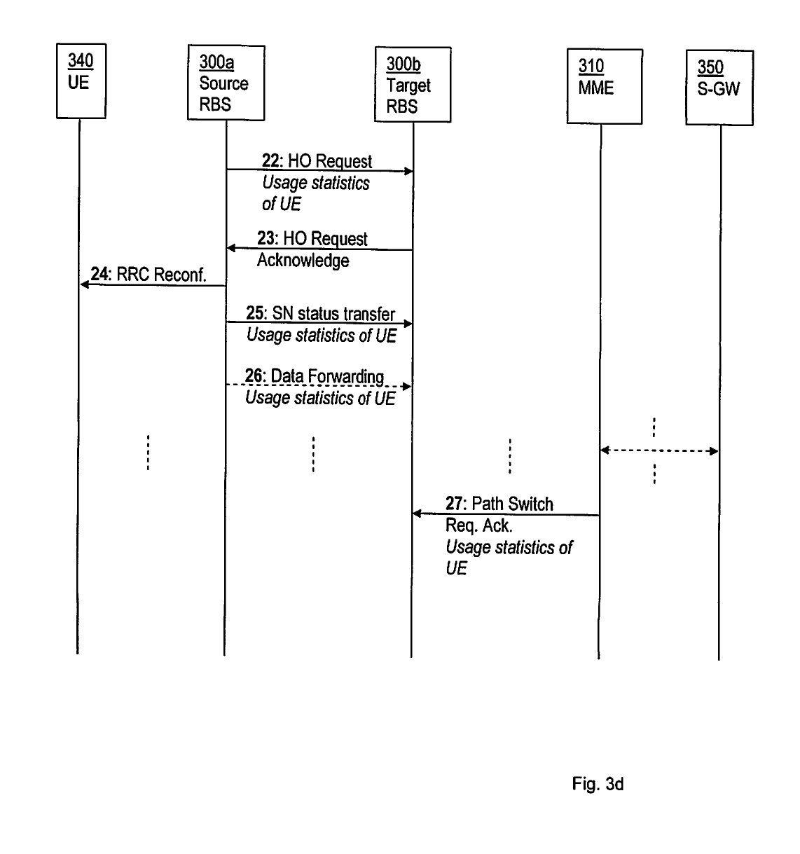

FIGS. 3a-3d are signalling diagrams illustrating exemplifying messages to be used for the RBS to receive usage statistics information. It shall be noted that FIGS. 3a-3d are schematic signalling diagrams and only some exemplifying signals are illustrated in the diagrams. Further, the signals in FIGS. 3a-3d are numbered from 1 to 27. It shall be noted that the four signalling diagrams are independent of each other and as a consequence, the signals 1-10 in signalling diagram 3a need not take place in one RBS before signals 15-21 in signalling diagram 3c take place in the same RBS. Likewise for signals 1-10 in signalling diagram 3a and 22-27 in signalling diagram 3d, and so on. The numbering is chosen such that there will not be a signal number 1, a signal number 2 and so on in all four signalling diagrams.

FIG. 3a is a schematic signalling diagram of a UE 340 requesting use of a service. Firstly, the UE 340 needs to establish a connection to the network, by establishing a connection to the RBS 300a. FIG. 3a illustrates the UE 340 sending a signal 1: RRC Connect Request to the RBS 300a, comprising an International Mobile Subscriber Identity (IMSI) or a random number (RND) as identity initially if no temporary identity is available. The RBS 300a responds to the UE 340 by sending a signal 2: RRC Connect Setup, and the UE 340 responds by sending a signal 3: RRC Connection Setup Request to the RBS 300a. The RBS 300a then sends a signal 4: Initial UE Message to the MME 310. Thereafter, a plurality of messages is exchanged between the MME 310, the RBS 300a and the UE 340. These are not described here in detail for simplicity reasons and in FIG. 3a they have been omitted and this is illustrated by dotted vertical lines. Once authentication procedures are completed, the MME sends a signal 5: Create Session Request comprising IMSI, International Mobile Equipment Identity (IMEI), Evolved Packet System (EPS) bearer identification and quality of service (QoS) to a Serving Gateway (S-GW) 350. The S-GW 350 responds to the MME 310 with a signal 6: Create Session Response comprising EPS bearer identification. Now the MME 310 sends a signal 7: Initial Context Setup Request to the RBS 300a. This signal comprises among other information Evolved Universal Terrestrial Radio Access Network (E-UTRAN) Radio Access Bearer (E-RAB), Non Access Stratum (NAS). In one example, the signal 7: Initial Context Setup Request also comprises the usage statistics of the UE 340. Thereafter the RBS 300a sends a signal 8: RRC Connection Reconfiguration to the UE 340, which responds to the RBS 300 with a signal 9: RRC Connection Reconfiguration Complete. Then the RBS 300a sends a signal 10: initial Context Setup Response to the MME 310.

As an alternative to sending the usage statistics of the UE to the RBS 300a in the signal 7: Initial Context Setup Request, a new dedicated signalling message is created in order for the RBS 300a to receive the usage statistics of the UE. Once the RBS 300a has received the usage statistics of the UE, the RBS 300a is enabled to determine at least one parameter relating to the provision of the service to the UE as has been described above.

FIG. 3b is a schematic signalling diagram of an exemplifying message to be used by the MME 310 to send usage statistics of the UE to the RBS 300a. It shall be noted that the numbering of the signals continues from FIG. 3a. This is so that the numbering between FIGS. 3a to 3d is separated. However, it shall be noted that the signals 1-10 in FIG. 3a need not have been exchanged between the different nodes before the signal messages of FIG. 3b take place. Likewise, in FIG. 3b, signals 11 and 12 need not take place before signals 13 and 14 take place.

In FIG. 3b, the RBS 300 receives a signal 11: E-RAB Setup Request from the MME 310. This is a request for setting up an EUTRAN-RAB. In one example, this signal comprises the usage statistics of the UE. The RBS 300a responds by sending a signal 12: E-RAB Setup Response. Again, once the RBS 300a has received the usage statistics of the UE, the RBS 300a is enabled to determine at least one parameter relating to the provision of the service to the UE as has been described above.

Further in FIG. 3b, an example is illustrated in which the UE context is modified and/or updated, which is then sent to the RBS 300a. The MME 310 sends a signal 13: UE Context Modification Request to the RBS 300a. In one example, this signal comprises the usage statistics of the UE. The RBS 300a responds by sending a signal 14: UE Context Modification Response. Once the RBS 300a has received the usage statistics of the UE, the RBS 300a is enabled to determine at least one parameter relating to the provision of the service to the UE as has been described above. In one example, the signal 13: UE Context Modification Request is used when the usage statistics of the UE has been updated and is sent to the RBS 300a.

FIG. 3c is a signalling diagram schematically illustrating an S1 handover and examples of different signals to use in order for the target RBS 300b to receive usage statistics of the UE. In this example, the UE 340 is being served by a source RBS 300a and a S1 handover is taking place to the target RBS 300b. As the target RBS 300b is to start serving the UE 340, the target RBS 300b needs to determine different parameters relating to the provision of the service. The procedure is illustrated with the source RBS 300a sending a signal 15: HandOver Request to the MME 310. The signal 15: HandOver Request comprises e.g. E-RAB, handover type, cause, transport configuration and RRC context. The MME 310 sends a signal 16: HandOver Request to the target RBS 300b. This signal 16: HandOver Request comprises mostly the same information as the signal 15: HandOver Request. In one example, the signal 16: HandOver Request also comprises the usage statistics of the UE which in this manner is received by the target RBS 300b. The S1 handover procedure continues with the MME 310 sending a signal 17: HandOver Command to the source RBS 300a, which in turn sends a signal 18: RRC Reconfiguration to the UE 340 informing the UE that it is to set up a connection with the target RBS 300b. The source RBS 300a also informs the MME 310 that it has instructed the LIE 340 to set up a connection to the target RBS 300b by sending a signal 19: Status Transfer to the MME 310. The MME 310 in turn sends a signal 20: Status Transfer to the target RBS 300b. In one example, the signal 20: Status Transfer comprises the usage statistics of the UE which in this manner is received by the target RBS 300b. Thereafter, other signalling may take place which is omitted in FIG. 3c for simplicity reasons, and the handover procedure is finalised by the source RBS 300a sending a signal 21: UE Context Release Complete to the MME 310.

FIG. 3c thus gives two examples of signals to use for the RBS to receive the usage statistics of the UE from the MME, signal 16: HandOver Request and signal 20: Status Transfer.

FIG. 3d is a signalling diagram schematically illustrating an X2 handover and examples of different signals to use in order for the target RBS 300b to receive usage statistics of the UE. In this example, the UE 340 is being served by a source RBS 300a and an X2 handover is taking place to the target RBS 300b. As the target RBS 300b is to start serving the UE 340, the target RBS 300b needs to determine different parameters relating to the provision of the service. The procedure is illustrated with the source RBS 300a sending a signal 22: HandOver Request to the target RBS. The signal 22: HandOver Request comprises e.g. target Cell Identity (CID). In one example, signal 22: HandOver Request also comprises the usage statistics of the UE which in this manner is received by the target RBS 300b. The target RBS 300b responds to the source RBS 300a with a signal 23: HandOver Acknowledge. The source RBS 300a informs the UE 340 about the handover to the target RBS 300b by sending a signal 24: RRC Reconfiguration and the source RBS 300a also sends a signal 25: SN Status Transfer to the target RBS 300b. In one example, the signal 25: SN Status Transfer comprises the usage statistics of the UE which in this manner is received by the target RBS 300b. Optionally, the source RBS 300a send a signal 26: Data Forwarding to the target RBS 300b, wherein the source RBS 300a transfers data information to the target RBS 300b. In still an example, the signal 26: Data Forwarding comprises the usage statistics of the UE which in this manner is received by the target RBS 300b. Thereafter, signalling takes place between the target RBS 300b, the MME 310, the S-GW 350 which has been omitted for simplicity reasons. FIG. 3d illustrates the MME sending a signal 27: Path Switch Request Acknowledge to the target RBS 300b. In yet an example, the signal 27: Path Switch Request Acknowledge comprises the usage statistics of the UE which in this manner is received by the target RBS 300b.

FIG. 3d thus provides four different exemplifying signals to be used for the target RBS to receive the usage statistics of the UE. Three examples are given for the source RBS 300a to send the usage statistics of the UE to the target RBS 300b: signal 22: HandOver Request, signal 25: SN Status Transfer and signal 26: Data Forwarding. A fourth example is the MME 310 sending the usage statistics of the UE to the target RBS 300b: the signal 27: Path Switch Request Acknowledge. In other words, the target RBS 300b may receive the usage statistics of the UE from the source RBS 300a or the MME 310.

In the examples described above with reference to FIGS. 3a to 3d, wherein the RBS 300a, 300b receives the usage statistics of the UE from the MME 310, the usage statistics of the UE is received by the RBS 300a, 300b either in existing standardised signalling messages which are updated to as to comprise the usage statistics of the UE, or in dedicated proprietary signalling messages. The same is valid for the examples when the target RBS 300b receives the usage statistics of the UE from the source RBS 300a.

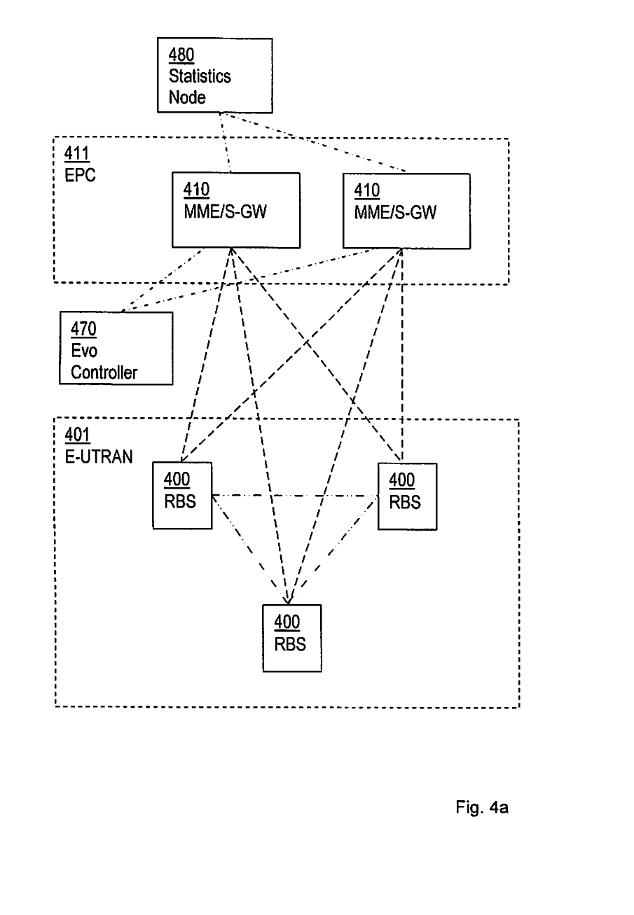

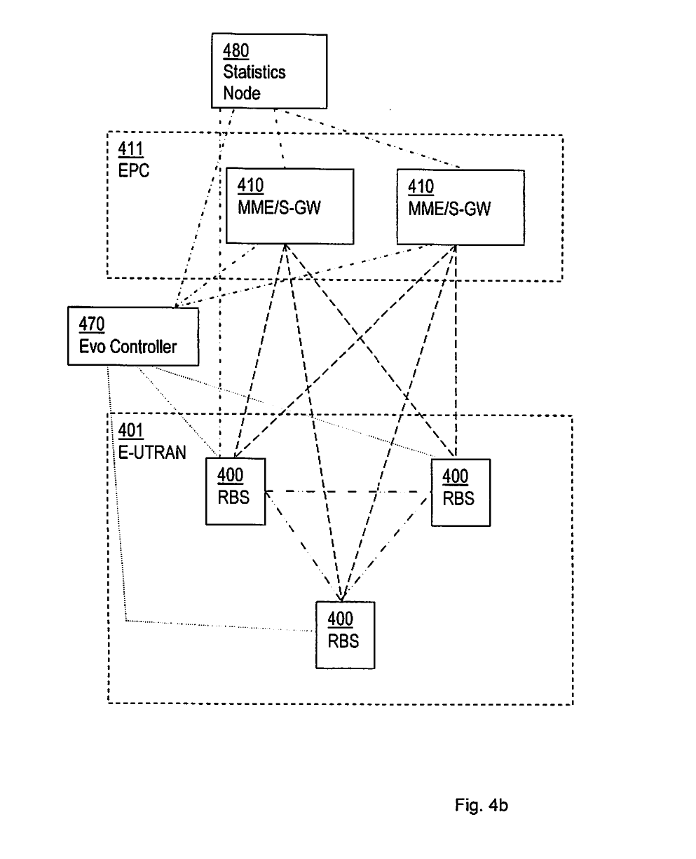

FIGS. 4a and 4b are block diagrams illustrating two examples of implementation of a statistics node in a wireless communication network.

FIG. 4a illustrates an example wherein a statistics node 480 is implemented as a standalone node. The statistics node 480, or UE knowledge node, is arranged to be in communication with the MME or the S-GW 410. The MME/S-GW 410 are illustrated to be comprised in an Evolved Packet Core (EPC) 411. In the example that the statistics node 480 is arranged to be in communication with the MME, then the MME receives the usage statistics of the UEs from the statistics node 480 which the MME 410 then forwards to the RBSs 400. The usage statistics of the UEs are forwarded to the RBSs 400 in the manner as having been described above with reference to FIGS. 3a to 3d. In the example that the statistics node 480 is arranged to be in communication with the S-GW, then the MME receives the usage statistics of the UEs from the S-GW and then forwards the usage statistics of the UEs to the RBSs 400 in the manner as having been described above with reference to FIGS. 3a to 3d. For sake of completeness, the RBSs 400 are illustrated as being part of the E-UTRAN 401.

The MME is in one example in charge of getting or retrieving the usage statistics of the UEs. In such a scenario, the MME is adapted to request and receive the usage statistics of the UEs from the statistics node 480.

The MME is in another example not in charge of getting or retrieving the usage statistics of the UEs, but instead an external source, e.g. an Evo Controller 470, is adapted to be in charge of providing the MME/S-GW 410 with the usage statistics of UEs. The Evo Controller 470 is a radio network node which, in one example, is also adapted to perform deep packet inspection and to perform caching etc. Several nodes exist that may collect and aggregate usage statistics depending on the type of communication network and the node may be implemented in the Radio Access Network (RAN) or in the Core Network (CN). In the example of the communication network being LTE and that the node which is adapted to collect and aggregate usage statistics is implemented in the RAN, then the eNode B (eNB) is an example of such a node and the Evo Controller is another example. In the example of the communication network being Wideband Code Division Multiple Access (WCDMA) and that the node which is adapted to collect and aggregate usage statistics is implemented in the RAN, then a Radio Network Controller (RNS) is an example of such a node. In the example that the node being adapted to collect and aggregate usage statistics is implemented in the CN, then some examples of such a node are MME, Policy Controller (PCRF) and a Home Location Register (HLR).

FIG. 4b illustrates an example wherein a statistics node 480 is implemented as a standalone node. The statistics node 480, or UE knowledge node, is arranged to be in communication with the MME or the S-GW 410. The MME/S-GW 410 are illustrated to be comprised in an Evolved Packet Core (EPC) 411. The difference between FIGS. 4a and 4b is that the Evo Controller 470 is arranged to be able to communicate with the RBSs 400. In FIG. 4b, the above described examples of how the usage statistics of UEs is received by the RBSs are still possible. FIG. 4b illustrates yet an example of the RBSs receiving the usage statistics of UEs, namely by means of the Evo Controller 470. In this scenario, the Evo Controller 470 is arranged to communicate with the RBSs 400 and the send the usage statistics of UEs to the RBSs 400. Further, in this scenario, dedicated signalling messages are used in order for the Evo Controller 470 to send the usage statistics of UEs to the RBSs 400. The Evo Controller 470 is in one example in charge of getting or retrieving the usage statistics of UEs and in another example the Evo Controller 470 receives the usage statistics of UEs from the statistics node 480.

In yet an example, the RBSs 400 are responsible for getting or retrieving the usage statistics of UEs. The RBSs 400 are then adapted to pull the usage statistics of UEs from either the Evo Controller 470, the MME/S-GW 410 or the statistics node 480.

In an alternative example to the examples illustrated in FIGS. 4a and 4b, the statistics node is incorporated into the MME or the S-GW.

It should be noted that FIG. 2 merely illustrates various functional units and modules in the RBS in a logical sense. The functions in practice may be implemented using any suitable software and hardware means/circuits etc. Thus, the embodiments are generally not limited to the shown structures of the RBS and the functional units and modules. Hence, the previously described exemplary embodiments may be realised in many ways. For example, one embodiment includes a computer-readable medium having instructions stored thereon that are executable by the processing unit 205 for performing the method. The instructions executable by the computing system and stored on the computer-readable medium perform the method steps of the present invention as set forth in the claims.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1-21. (canceled)

22. A method in a radio base station, in a wireless communication network, for providing service to a user equipment, the method comprising:
establishing a connection between said user equipment and the radio base station;
receiving, from a network node, usage statistics of the user equipment; and
determining at least one parameter relating to the provision of the service to the user equipment, based on said received usage statistics of the user equipment.

23. The method according to claim 22, wherein the at least one parameter relating to the provision of the service to the user equipment relates to handover from the radio base station to a target radio base station.

24. The method according to claim 22, wherein the at least one parameter relating to the provision of the service to the user equipment relates to length of periods of user inactivity allowed before the radio base station initiates a release of the user equipment.

25. The method according to claim 22, wherein the establishing of the connection comprises receiving a connection request message from said user equipment and setting up connection to a Mobile Management Entity, MME.

26. The method according to claim 22, wherein the establishing of the connection comprises receiving a handover request message from a Mobile Management Entity, MME, and executing the handover.

27. The method according to claim 22, wherein the establishing of the connection comprises receiving a handover request message from a source radio base station and executing the handover.

28. The method according to claim 22, wherein said received usage statistics of the user equipment comprises a recommended parameter configuration, and wherein determining the at least one parameter relating to the provision of the service to the user equipment is based at least partly on said parameter configuration.

29. The method according to claim 22, further comprising receiving, from the network node, updated usage statistics of the user equipment from a Mobile Management Entity, MME, and re-determining the at least one parameter relating to the provision of the service to the user equipment based on said received usage statistics of the user equipment.

30. The method according to claim 22, further comprising receiving, from the network node, a value for at least one parameter relating to the provision of the service to the user equipment and determining the at least one parameter relating to the provision of the service to the user equipment according to said received value.

31. A radio base station in a wireless communication network, the radio base station being adapted to provide service to a user equipment, and being further adapted to:
establish a connection between said user equipment and the radio base station;
receive, from a network node, usage statistics of the user equipment; and
determine at least one parameter relating to the provision of the service to the user equipment, based on said received usage statistics of the user equipment.

32. The radio base station according to claim 31, wherein the at least one parameter relating to the provision of the service to the user equipment, relates to handover from the radio base station to a target radio base station.

33. The radio base station according to claim 31, wherein the at least one parameter relating to the provision of the service to the user equipment, relates to length of periods of user inactivity allowed before the radio base station initiates a release of the user equipment.

34. The radio base station according to claim 31, wherein the radio base station is adapted to establish the connection by receiving a connection request message from said user equipment and setting up connection to a Mobile Management Entity, MME.

35. The radio base station according to claim 34, wherein said network node is the MME.

36. The radio base station according to claim 34, wherein said network node is a statistics node comprising usage statistics of user equipments and located in a radio access network or a core network of the wireless communication network.

37. The radio base station according to claim 31, wherein the radio base station is adapted to establish the connection by receiving a handover request message from a Mobile Management Entity, MME, and executing the handover.

38. The radio base station according to claim 31, wherein the radio base station is adapted to establish the connection by receiving a handover request message from a source radio base station and executing the handover.

39. The radio base station according to claim 38, wherein said network node is the source radio base station.

40. The radio base station according to claim 31, wherein said received usage statistics of the user equipment comprises a recommended parameter configuration, and wherein the radio base station is adapted to determine the parameters relating to the provision of the service to the user equipment based at least partly on said recommended parameter configuration.

41. The radio base station according to claim 31, wherein the radio base station is adapted to receive updated usage statistics of the user equipment from a Mobile Management Entity, MME, and to re-determine the parameters relating to the provision of the service to the user equipment, based on said received updated usage statistics of the user equipment.

42. The radio base station according to claim 31, wherein the radio base station is adapted to receive a value for at least one parameter relating to the provision of the service to the user equipment and to determine the at least one parameter relating to the provision of the service to the user equipment according to said received value.
